(19) United States
(12) Patent Application Publication
(10) Pub. No.: US 2024/0362897 A1
(43) Pub. Date: Oct. 31, 2024

(54) SYNTHETIC DATA GENERATION USING VIEWPOINT AUGMENTATION FOR AUTONOMOUS SYSTEMS AND APPLICATIONS

(71) Applicant: NVIDIA Corporation, Santa Clara, CA (US)

(72) Inventors: Tzofi Klinghoffer, Somerville, MA (US); Jonah Philion, Toronto (CA); Zan Gojcic, Zurich (CH); Sanja Fidler, Toronto (CA); Or Litany, Sunnyvale, CA (US); Wenzheng Chen, Toronto (CA); Jose Manuel Alvarez Lopez, Mountain View, CA (US)

(73) Assignee: NVIDIA Corporation, Santa Clara, CA (US)

(21) Appl. No.: 18/634,134

(22) Filed: Apr. 12, 2024

Related U.S. Application Data
(60) Provisional application No. 63/459,355, filed on Apr. 14, 2023.

(51) Int. Cl. G06V 10/774; G06T 7/55; G06T 15/20

(52) U.S. Cl. CPC G06V 10/774; G06T 7/55; G06T 15/205; G06T 2207/10016; G06T 2207/20081; G06T 2207/20084; G06T 2207/30181; G06T 2207/30252

(57) ABSTRACT

In various examples, systems and methods are disclosed relating to synthetic data generation using viewpoint augmentation for autonomous and semi-autonomous systems and applications. One or more circuits can identify a set of sequential images corresponding to a first viewpoint and generate a first transformed image corresponding to a second viewpoint using a first image of the set of sequential images as input to a machine-learning model. The one or more circuits can update the machine-learning model based at least on a loss determined according to the first transformed image and a second image of the set of sequential images.

### CROSS-REFERENCE TO RELATED APPLICATIONS

The present application claims the benefit of and priority to U.S. Provisional Application No. 63/459,355, filed Apr. 14, 2023, the contents of which are incorporated herein by reference in their entirety.

### BACKGROUND

Autonomous vehicles often use machine-learning models to process sensor data corresponding to their surrounding environments. However, it is challenging to provide machine-learning models that accurately process such sensor data captured at different poses/perspectives of the respective sensors that captured the sensor data.

### SUMMARY

Embodiments of the present disclosure relate to systems and methods for viewpoint augmentation for autonomous and semi-autonomous systems and applications. For example, the systems and methods presented herein provide improvements over conventional approaches for training machine-learning models that rely on training data that is captured from cameras or other sensors having fixed poses (e.g., perspectives or fields of view, due to camera elevation, orientation, etc.) relative to a moving machine. To generalize machine-learning models using such approaches, data must be recaptured manually at a variety of different poses, which is impracticable to perform in practice, and creates a requirement that conventional training/updating techniques for machine-learning models rely on sensor data for inference that is captured using sensors that match the pose of the sensors that captured training data for the machine-learning models. If the pose is not generally matched, the machine-learning models may suffer from performance degradation.

The systems and methods described herein improve upon conventional training/updating techniques for machine-learning models by automatically generating data for training/updating processes at augmented viewpoints. The techniques described herein can be used to realistically transform images such that they appear as though they are captured at a different, specified pose/viewpoint—or even from sensors with different characteristics. This process can be repeated for several images at several arbitrary poses, allowing for the rapid generation of sets of data for training/updating machine-learning models that are more generalizable to a variety of contexts-thereby improving overall model performance.

At least one aspect relates to a processor. The processor can include one or more circuits. The one or more circuits can. The one or more circuits can generate, using a machine-learning model and based at least on a first frame of a set of sequential images corresponding to a first viewpoint, a first transformed image corresponding to a second viewpoint. The one or more circuits can update or train (e.g., one or more parameters of) the machine-learning model based at least on a loss determined according to the first transformed image and a second image of the set of sequential images.

In some implementations, the one or more circuits can identify a respective depth map associated with each image of the set of sequential images. In some implementations, the one or more circuits can update or train (e.g., one or more parameters of) the machine-learning model further based at least on a second loss determined according to depth values of one or more mesh faces of an output of the machine-learning model and a respective depth map associated with the second image. In some implementations, the one or more circuits can update or train (e.g., one or more parameters of) the machine-learning model further based at least on a third loss determined according to an estimated depth map of the output of the machine-learning model and a respective depth map associated with the first image.

In some implementations, the one or more circuits can generate at least one mask for at least one image of the set of sequential images. In some implementations, the one or more circuits can generate the at least one mask using a second machine-learning model updated/trained to predict the at least one mask to correspond to one or more objects depicted as proximate to a device that captured the at least one image. In some implementations, the one or more circuits can generate the at least one mask using a second machine-learning model updated/trained to predict the at least one mask to correspond to a sky depicted in the at least one image.

In some implementations, the one or more circuits can update or train (e.g., one or more parameters of) the machine-learning model to render the output in the second viewpoint of the second image of the set of sequential images. In some implementations, the loss comprises one or more of an L1 loss, a structural similarity (SSIM) loss, or a minimal loss. In some implementations, the one or more circuits can execute the machine-learning model to generate a set of transformed images (e.g., as training set for second viewpoint) corresponding to at least the second viewpoint. In some implementations, the one or more circuits can update a second machine-learning model using the set of transformed images.

Another aspect relates to a system. The system can include one or more processors. The one or more circuits can identify a first set of images corresponding to a first viewpoint. The one or more circuits can generate, using a machine-learning model and based at least on the first set of images, a second set of images corresponding to the first set of images and a second viewpoint. The one or more circuits can update/train (e.g., one or more parameters of) a second machine-learning model using a dataset comprising the second set of images.

In some implementations, the one or more processors can iteratively execute the machine-learning model using a first image of the first set of images as input to generate a plurality of images included in the second set of images, each of the plurality of images corresponding to a respective viewpoint different from the first viewpoint. In some implementations, the one or more processors can execute the machine-learning model further using at least an indication of the second viewpoint. In some implementations, the second machine-learning model comprises a segmentation model.

Yet another aspect of the present disclosure is related to a method. The method can include identifying a set of sequential images corresponding to a first viewpoint. The method can include generating a first transformed image corresponding to a second viewpoint, using a first image of the set of sequential images as input to a machine-learning model. The method can include updating or training (e.g., one or more parameters of) the machine-learning model based at least on a loss determined according to the first transformed image and a second image of the set of sequential images.

In some implementations, the method can include identifying a respective depth map associated with each image of the set of images. In some implementations, the method can include updating or training (e.g., one or more parameters of) the machine-learning model further based at least on a second loss determined according to depth values of one or more mesh faces of the output of the machine-learning model and a respective depth map associated with the second image.

In some implementations, the method can include updating or training (e.g., one or more parameters of) the machine-learning model further based at least on a third loss determined according to an estimated depth map of the output of the machine-learning model and a respective depth map associated with the first image. In some implementations, the method can include generating, using the one or more processors, at least one mask for at least one image of the set of sequential images.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for performing generative AI operations, a system for performing operations using a language model-such as a large language model (LLM) or a video language model (VLM), a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for augmenting viewpoints using machine-learning models are described in detail below with reference to the attached drawing figures, wherein:

FIG. 1 is a block diagram of an example system that implements viewpoint augmentation for autonomous or semi-autonomous driving, in accordance with some embodiments of the present disclosure;

FIG. 2 illustrates an example dataflow diagram showing how viewpoint augmentation can be used to transform images to specified viewpoints for training/updating machine-learning models, in accordance with some embodiments of the present disclosure;

FIG. 3 illustrates example images showing how an original image is transformed into several different viewpoints, in accordance with some embodiments of the present disclosure;

FIG. 4 is a flow diagram of an example of a method for using viewpoint augmentation to transform images to specified viewpoints, in accordance with some embodiments of the present disclosure;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

This disclosure relates to systems and methods for augmenting viewpoints in training data for updating/training artificial intelligence models implemented for autonomous or semi-autonomous systems and applications. Autonomous and semi-autonomous machine can use neural networks or other machine-learning models for perception during operation. To accommodate variations in types of autonomous or semi-autonomous machines, as well as variations in poses of sensors that capture visual data, the machine-learning models are trained/updated to be robust. These problems are compounded by the fact that vision-based machine-learning models are sensitive to changes in viewpoint, sensor type, sensor model, sensor performance information (e.g., resolution, focal length, etc.), pose, location on vehicle (e.g., height, lateral location, etc.), etc. For example, small changes to pitch, yaw, depth, or height of sensors at inference time can cause large drops in performance.

Traditional approaches for ensuring machine-learning models are robust to different viewpoints require repeated data collection and labeling of additional training datasets for each additional viewpoint or sensor pose. This process of data collection and labeling becomes technically impracticable to perform for different vehicles or sensor poses. For example, additional datasets can be required for each new type or model of vehicle with which autonomous or semi-autonomous operations are implemented.

The systems and methods of the present disclosure provide techniques for generating training datasets for arbitrary target viewpoints, poses, sensor data types, sensor models, sensor characteristics, etc. by transforming collected data to the viewpoints, poses, sensor data types, sensor models, sensor characteristics, etc. of target sensors. By transforming existing data rather than manually collecting and labeling new data for pose, viewpoint and/or position, machine-learning models can be trained for diverse targets without requiring creation of new datasets for each additional viewpoint. To generate training data having the target viewpoints, the systems and methods described herein generate a three-dimensional (3D) scene mesh by warping/conforming a lattice grid onto a scene (e.g., an input image) based at least on predicted depths and vertex offsets of each pixel in the scene.

A machine-learning model (e.g., a machine-learning pipeline) is used to generate the mesh and can render the mesh according to the target viewpoint. The machine-learning pipeline includes training/updates (e.g., to weights, biases, parameters of the model(s)) to ensure temporal consistency between sequentially captured images or other sensor data representations (e.g., point clouds, etc.). To do so, a machine-learning pipeline is trained end-to-end on a multi-view consistency loss. End-to-end training/updating can be performed using a set of temporally sequential images. During training/updating, for every input image In, consistency can be enforced between In−1 and In+1 by transforming In−1 and In+1 into the viewpoint of In, using the machine-learning pipeline. The resulting transformed images are compared with the In, using a suitable loss function. In some implementations, the loss function may include Structural Similarity Index Measure (SSIM) loss.

In some implementations, regions of the images may be masked to ignore camera motion assumptions or other artifacts or features. Light-detection and ranging (LiDAR) sensor data can be used as a ground truth sparse depth map for each image in the set of temporally sequential images. The LiDAR data may be used in connection with similar techniques to those described above to calculate a depth loss for the images in the sequence. In some implementations, the depth loss can be calculated based at least on a direct depth loss (e.g., comparing the depth of an input image and its corresponding ground truth LiDAR depth data) and a rendered depth loss (e.g., comparing the depth after projection into the viewpoint of neighboring frame(s), etc.).

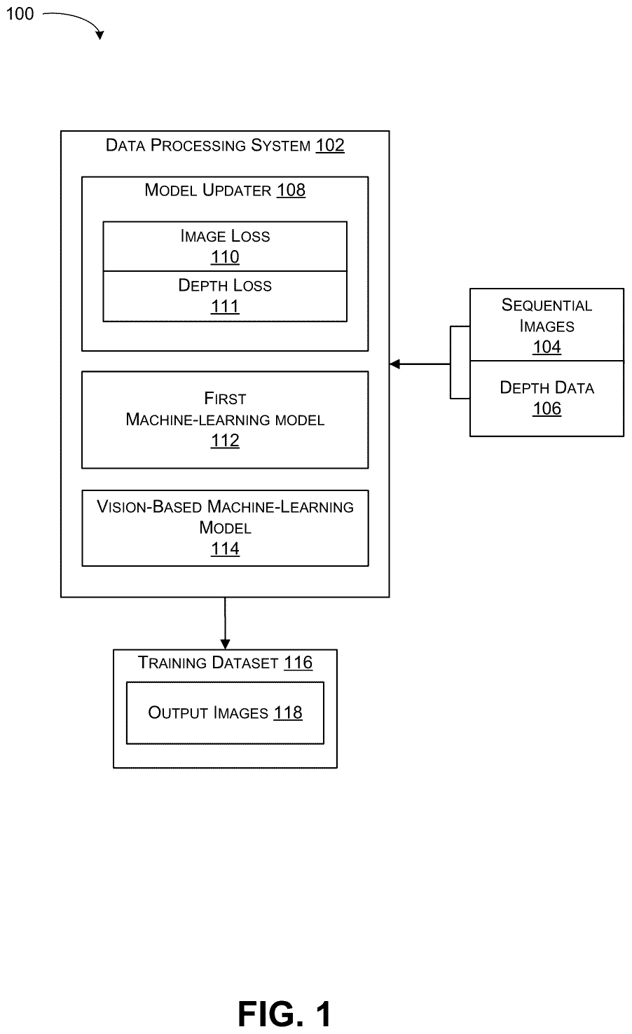

FIG. 1 is an example computing environment including a system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine-learning model), operation, routine, logic, or instructions to perform functions such as training/updating machine-learning models to transform images to specified viewpoints.

The system 100 is shown as including the data processing system 102, one or more sets of sequential images 104 (or other sensor data representations, such as point clouds, range images, etc.), one or more sets of depth data 106, and a training dataset 116. The data processing system 102 is shown as including a model updater 108, a first machine-learning model 112 (sometimes referred to herein as a “first model 112”), and a vision-based machine-learning model 114 (sometimes referred to herein as a “vision-based model 114”). The training dataset 116 is shown as including one or more output images 118 (and/or other sensor data representations). The data processing system 102, or the components thereof, can access the one or more sets of sequential images 104 and the one or more sets of depth data 106 to train/update the first machine-learning model 112.

The one or more sets of sequential images 104 and the one or more sets of depth data 106 may be maintained via an external server, distributed storage/computing environment (e.g., a cloud storage system), or may be stored via memory of the data processing system 102. The data processing system 102, or the components thereof, can access the training dataset 116 to train/update the vision-based machine-learning model 114. The training dataset 116, which is shown as including one or more output images (which may be generated based at least on the first model 112, as described herein), may be maintained via an external server, distributed storage/computing environment (e.g., a cloud storage system), or may be stored via memory of the data processing system 102.

The data processing system 102 can execute the model updater 108 to train/update the first model 112. The first model 112 can be trained/updated to transform/translate input images (e.g., captured by one or more image sensors of a vehicle, etc.) into specified target viewpoints. Doing so can enable the generation of diverse training datasets 116 having many different viewpoints, without requiring manual collection or generation of datasets captured at different sensor poses. To train/update the first model 112, the model updater 108 can identify one or more set of sequential images 104. Each image in each set of sequential images 104 can correspond to a viewpoint or pose at which the image was captured.

In one example, each image in a set of set of sequential images 104 can be captured in a temporal sequence, for example, as a vehicle traverses a route. In such implementations, a sequence of images 104 can be captured using one or more image sensors positioned on the vehicle, including but not limited to cameras, image capturing devices, or video capturing devices, among others. A set of sequential images 104 can include any number of corresponding images that are captured in a temporal sequence. In some implementations, each image the set of sequential images 104 can be captured according to a predetermined frame rate (e.g., 10 frames per second, 20 frames per second, 30 frames per second, 60 frames per second, etc.).

As sequentially ordered images in a set of sequential images 104 are captured in temporal proximity to one another, each image in the set of sequential images 104 (except for the very first image) can include information also captured in the immediately previous image in the set of sequential images 104. Each set of sequential images 104 can capture information from an environment, for example, an environment in which vehicles or machines operate (e.g., a road, a roadway, a warehouse, a parking lot/garage, a building, a park, a common area, etc.). The environment depicted in each set of sequential images 104 may include any number of objects, obstacles, or other data relevant to vehicle or machine navigation. In some implementations, each image of the set of sequential images 104 can be stored in association with corresponding label data. The label data can be used as ground truth data for training/updating the vision-based model 114, as described in further detail herein. The label data may include segmentations of objects/features depicted in each image in a set of sequential images 104, classifications of objects/features depicted in each image, bounding shape indications of objects/features in each image, or other types of label data for training/updating the vision-based model 114.

As shown, each set of sequential images 104 can be stored in association with a corresponding set of depth data 106. The depth data 106 for a set of sequential images 104 can include one or more depth maps, point clouds, or other depth information captured at the same time as each image in the set of sequential images 104. Each set of depth data 106 therefore includes depth maps that respectively correspond to each image in a respective set of sequential images 104. The depth data 106 can be captured using one or more depth sensors, such as a LiDAR sensor or a RADAR sensor, red-green-blue-depth (RGBD) image sensors, among others. Depth maps included in a set of depth data 106 can include corresponding depth values for each pixel in an image of a corresponding set of sequential images 104. Said depth information may be depth relative to the sensor that captured the image, in some implementations. The depth data 106 can be used by the model trainer 108 to calculate the depth loss 111, as described herein.

Identifying the sets of sequential images 104 (and corresponding depth data 106) can include retrieving said information for a training/updating process of the first model 112. For example, in some implementations, the data processing system 102 can receive a request from an external computing system or from input to the data processing system 102 to train/update the first model 112. The request can specify parameters for training/updating, including a number of training/updating samples to be used, particular sets of sequential images 104 and depth data 106 to access for the training/updating process, among other parameters. The one or more sets of sequential images 104 and depth data 106 may be received or retrieved from one or external computing systems, provided in a request to train/update the first model 112, or maintained in storage of the data processing system 102 for processing. In some implementations, the data processing system 102 can receive an identifier of one or more sets of sequential images 104 and/or depth data 106 and can retrieve the identified data from one or more external or internal storage systems using the identifier(s).

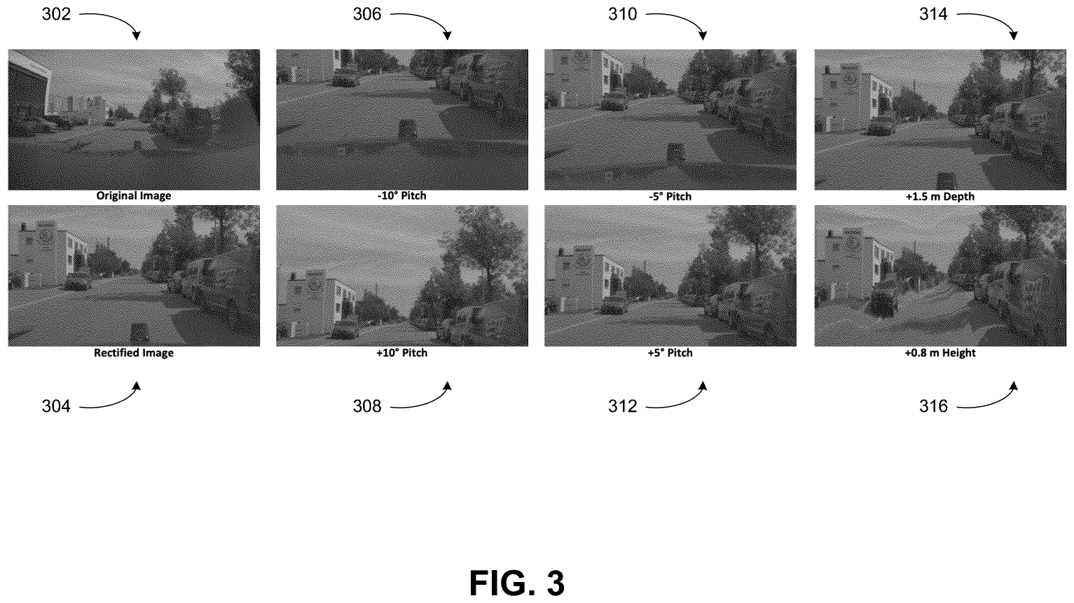

The request to train/update the first model 112 may include data indicating how each image in a set of sequential images 104 is to be transformed. As described herein, the first model 112 can be trained/updated to transform an input image captured in a source pose into a transformed image that appears as if the input image were captured in a target pose that is different from the source pose. In specifying the one or more sets of sequential images 104 to access for training/updating, the request can further identify how one or more images of the one or more sets of sequential images 104 are to be transformed during the training/updating process. Examples of various image pose transformations are shown in FIG. 3 and can include but are not limited to pitch transformations, height transformations, and distance transformations, among others.

Upon identifying the one or more sets of sequential images 104 and depth data 106, the model updater 108 can train/update the first model 112 to transform images according to specified target viewpoints/poses/sensor parameters/etc. To do so, the model updater 108 can execute the first model using a first image of a set of sequential images 104 as input, along with a corresponding indication of a target pose to which to transform the viewpoint of the first image. The set of sequential images 104 may be a set of sequential images 104 selected for training/updating the first model 112. In some implementations, the first image is selected randomly or pseudo-randomly from the set of sequential images 104. In some implementations, the first image is selected according to one or more rules or configuration settings specified in the request to train/update the first model 112 or stored at the data processing system 102.

The first model 112 can include one or more suitable machine-learning model(s) that can generate corresponding output images in a target viewpoint from an input image captured at a source viewpoint. In some implementations, the first model 112 can include one or more convolutional neural network models, including one or more pre-trained or pre-updated image processing neural network models. Such neural networks may include any number or type of layers suitable for machine-learning operations, including convolutional layers, activation layers, pooling layers, or fully connected layers, among others.

The first model 112 can generate transformed images in an output by first mapping the input image onto a lattice grid (sometimes referred to herein as a “lattice” or a “sheet”) onto the input image. To do so, the model trainer 108 can first generate a lattice grid of points, where a number and position of each point in the lattice is determined according to a predetermined width and height of the lattice. Each point in the lattice can be uniformly positioned in the lattice, in some implementations, and each point can share the same depth value. By initially sharing the same depth value, the lattice is initially a flat surface represented by each of the points in the lattice. The model trainer 108 can execute one or more neural networks of the first model 112 to predict, for each point in the lattice, an amount by which to warp the depth and grid position of each point relative to its starting position, according to features extracted from the input image.

The lattice, or mesh, can be represented as M=({V_{(x,y)}}, {F}), where V_{(x,y)} corresponds to a vertex at position (x, y), and F is the set of mesh faces defined by the vertices. The depth of each vertex can be represented as z. Given an input image I, the first model 112 can be trained to predict a depth value z, as well as a grid offset for each vertex V_{(x,y)} in the mesh M. To calculate the depth values and grid offsets for each vertex, the first model 112 can receive the image I as input, along with the target pose et. The predicted depth values and grid offsets, once generated, can be used to modify the positions of each vertex in the mesh to create a warped mesh. In one example, the first model 112 can include a differentiable texture sampler that can splat red-green-blue (RGB) pixel intensities of the input image/of the set of sequential images 104 onto the UV texture map of the warped mesh. Any suitable texture mapping technique can be used to map the pixel intensities of the input image/to the warped mesh.

Once the warped mesh has been generated and the input image has been mapped to its surface as a texture, the model updater 108 can render the textured, warped mesh using a camera having a pose corresponding to the target viewpoint. As the mesh is predicted with respect to the input view of the input image I, altering the position of the camera in space relative to the mesh according to the target viewpoint enables the data processing system 102 to render the input image at the target pose. The rendered image can be stored as a transformed image in the target viewpoint, which can be compared to ground truth data to calculate a loss value used to train/update the first model 112.

As shown, the model updater 108 can use a combination of (e.g., a sum) of an image loss 110 and a depth loss 111. Calculating the image loss 110 for an input image can include performing transformations, as described herein, on temporally adjacent images in the set of sequential images 104. For example, as the set of sequential images 104 (sometimes represented as S) are temporally sequential, the first model 112 can be trained/updated to enforce temporal consistency between neighboring images in the set of sequential images 104. For each input image In, temporal consistency can be Iₙ₋₁ and Iₙ₊₁ by transforming Iₙ₋₁ and Iₙ₊₁ into the viewpoint of In and comparing each predicted view In to In as a ground truth. The images In-1 and In+1 can be transformed by executing the first model 112 to generate corresponding warped meshes according to the viewpoint of the image In, as described above. Predicted depth maps for each of the images Iₙ₋₁ and Iₙ₊₁ can be generated as described herein (e.g., as the depth value z).

Each of the images Iₙ₋₁ and Iₙ₊₁, and corresponding depth maps Dₙ₋₁ and Dₙ₊₁, when transformed to the viewpoint of the image In in the sequential images 104, can be represented according to the following equations:

$$\{ {Î}_{n}^{n + 1} , {\hat{D}}_{n}^{n + 1} \} = render ( \{ {V}_{( x , y , )}^{n + 1} \} , \{ {F}^{n + 1} \} , {T}^{n + 1} )$$

$$\{ {Î}_{n}^{n - I} , {\hat{D}}_{n}^{n - 1} \} = render ( \{ {V}_{( x , y , )}^{n + 1} \} , \{ {F}^{n + 1} \} , {T}^{n + 1} )$$

In the above equations, V are the vertices of the corresponding lattice/mesh, F are the faces of the lattice/mesh, and Tis the texture map applied to the mesh. Each of the meshes are rendered in the viewpoint of an image of the set of sequential images Iₙ. The images Iₙ₋₁ and Iₙ₊₁rendered in the viewpoint of the image In are represented as În E (îₙ₊₁, Îₙ₋₁). The corresponding depth maps of each image În are represented as Dₙ₊₁ and Dₙ₋₁.

The viewpoint of the image In can be calculated based on a driving information relating to when the set of sequential images 104 were captured, can be predetermined and provided as part of the set of sequential images 104, or may be determined based on additional sensor data (e.g., accelerometers from sensors on a vehicle used to capture the set of sequential images 104, etc.). In some implementations, the pose of the image In can be calculated based on relative pose information stored in association with each of the images Iₙ₋₁ and Iₙ₊₁.

A pixel-wise loss, which maybe included as part of the image loss 110, is calculated according to the following equation:

$${L}_{im} = \frac{1}{𝒫} {\sum }_{i = 1}^{𝒫} min ( \vert {I}_{n , i} - {Î}_{n}^{n + 1} \vert , \vert {I}_{n , i} - {Î}_{n , i}^{n - 1} \vert )$$

In the above equation, Lᵢₘ is the pixel-wise loss of the image loss 110, [symbol] is the valid pixel number, and I_{n,i} is the ith pixel of the corresponding image Iₙ. In some implementations, certain pixels (e.g., relating to a sky area, trees, etc.) of the input image Iₙ (and their counterpart pixels in the generated images Îₙ₊₁ and Îₙ₋₁) can be automatically masked, and therefore considered invalid for the purposes of calculating the image loss 110.

In some implementations, the image In can be provided as input to a machine-learning model, such as a segmentation model, that detects whether pixels of an input image are to be masked. The segmentation model can be trained/updated according to any suitable masking criteria, including criteria for masking shadows created by a vehicle via which the sequential images 104 were captured, in one example. In another example, the segmentation model can be trained/updated to mask objects or vehicles that are detected as within a predetermined threshold distance of the device that captured the sequential images 104 (e.g., a roof of the vehicle within the field-of-view of the vehicle, other vehicles in close proximity to said vehicle, etc.). In some implementations, each image in a set of sequential images 104 can be stored in association with predetermined mask information for pixels that violate camera motion assumptions.

Since, in some implementations, a set of sequential images 104 is captured by sensors on a moving vehicle, occlusion may occur between individual sequential images. This occlusion can cause inaccuracies in the calculated loss, because such occlusion may not be presented in three sequential frames (e.g., Iₙ, Iₙ₋₁, and Iₙ₊₁). To address potential occlusion, in some implementations, the model updater 108 can implement a minimal loss technique by computing both losses between (Iₙ, Îₙⁿ⁻¹) and (Iₙ, Îₙⁿ⁺¹), and can select the minimum of each for calculating the image loss 110. Application of minimal loss prevents occlusions from affecting the total image loss 110, as it is less likely that occlusions will be present in both Iₙ₋₁ and Iₙ+1.

In some implementations, the model updater 108 can calculate the image loss 110 to include a structural similarity (SSIM) loss between the image Iₙ (as ground truth) and the generated image Îₙ. The SSIM loss can be calculated based on luminance (brightness), contrast, and structure between the ground truth image Iₙ and images Îₙ. An example equation representing the SSIM loss is provided below.

$$SSIM ( x , y ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )}$$

In the above example equation for SSIM loss, x and y are the images being compared (e.g., Iₙ and Îₙ), μx and μy are the average pixel values of x and y, respectively, σₓ² and σ_{y}² are the variances of x and y, respectively, σ_{xy} is the covariance of x and y, and C₁ and C₂ are constants to stabilize the division with weak denominator. In some implementations, the model updater 108 can include the SSIM loss in calculating a corresponding image loss 110 between each of (Iₙ, Îₙⁿ⁻¹) and (Iₙ, Îₙⁿ⁺¹), and select the minimum loss between each for calculating the image loss 110.

In addition to calculating an image loss 110 during training/updating of the first model 112, the model updater 108 can calculate a depth loss 111 according to the generated depth maps represented as \hat{D}ₙⁿ⁺¹ and \hat{D}ₙⁿ⁻¹ (e.g., collectively as \hat{D}ₙ). As described herein, sensors present on vehicles that capture sequential images 104 also include additional depth sensors, such as light detection and ranging (LiDAR) sensors, which can capture sets of depth data 106 that correspond respectively to sets of sequential images 104. In some implementations, the depth data 106 can include generated depth maps, which operate as ground truth depth data for each image in a set of sequential images 106. In some implementations, the model updater 108 can generate corresponding depth maps from sensor data included in the depth data 106. In an example where the depth data 106 includes a LiDAR point cloud corresponding to an image Iₙ of a set of sequential images 104, the model updater can generate a corresponding depth map Dₙ by rendering the LiDAR point cloud data into a depth map having the same width, height, and resolution as the corresponding image Iₙ of a set of sequential images 104. The model updater 108 can repeat this process for each image Iₙ of a set of sequential images 104.

In some implementations, when generating the depth map Dₙ for an image Iₙ of a set of sequential images 104, the model updater 108 can perform automatic masking of one of the depth map Dₙ to remove portions that may interfere with training/updating accuracy. In one example, the model updater 108 can perform masking of portions of the depth map Dₙ corresponding to the sky. To do so, the model updater 108 can provide the depth map Dₙ as input to one or more machine-learning models, such as segmentation machine-learning models trained/updated to identify portions of depth maps corresponding to sky. Each point in the depth map corresponding to the sky can be masked by storing said point in association with a flag indicating said point is in valid, in some implementations.

Additional masking may also be performed, for example, to mask any detected objects (e.g., proximate vehicles) or environmental features detected in the depth map Dₙ. Similar approaches (e.g., using pre-trained/updated machine-learning models, etc.) may be used to detect points in the depth map Dₙ corresponding to such objects/features. The model updater 108 can perform masking by updating each of the points in the depth map Dₙ as valid/invalid according to output of the machine-learning models. Said machine-learning models may include convolutional machine-learning models, which may be stored or otherwise accessed by the data processing system 102 and executed by the model updater 108 to mask portions of the depth maps Dₙ.

To calculate the depth loss 111, the model updater 108 can compare the predicted depth of each point on the mesh faces F of the predicted meshes for the respective images Iₙ₋₁ and Iₙ₊₁ to the ground truth depth maps Dₙ₋₁ and Dₙ₊₁ of the images Iₙ₋₁ and Iₙ₊₁. The comparison may be, in some implementations, calculated as an L1 loss. An example equation showing the L1 loss is shown in the equation below.

$${L}_{D}^{direct} = \frac{1}{𝒫} {\sum }_{i = 1}^{𝒫} \vert {D}_{n - 1 , i} - {F}_{depth} ( {I}_{n - 1 , i} ) \vert + \vert {D}_{n + 1 , i} - {F}_{depth} ( {I}_{n + 1 , i} ) \vert$$

Iₙ the above equation, L_{D}^{direct} is the L1 loss, [symbol] is the valid (e.g., unmasked) pixel number, D_{n,i} is the ith pixel of the corresponding depth map Dₙ, and F_{depth}(I_{n,i}) is the predicted depth at the corresponding pixel i of the image Iₙ.

In some implementations, the model updater 108 can calculate a rendered depth as part of the calculating the depth loss 111, in addition to or as an alternative to calculating the L1 depth loss. The rendered depth loss can compare the predicted depth and the ground truth depth after the prediction is projected into the viewpoint of the images Iₙ₊₁ and Iₙ₋₁. The rendered depth loss may be calculated as a second L1 depth loss. An example equation showing calculation of the rendered depth loss is provided below.

$${L}_{D}^{ren der} = \frac{1}{𝒫} {\sum }_{i = 1}^{𝒫} min ( \vert {D}_{n , i} - {\hat{D}}_{n}^{n + 1} \vert , \vert {D}_{n , i} - {\hat{D}}_{n , i}^{n - 1} \vert )$$

In the above equation, L_{D}^{render} is the depth render loss of the depth loss 1110, P is the valid pixel/point number, and D_{n,i} is the ith pixel/point of the corresponding depth map Dₙ (e.g., ground truth data). As described herein above, the model updater 108 can use the minimal loss (e.g., minimum of the loss with respect to the depth maps Dₙ₋₁ and Dₙ₊₁ as the rendered/direct depth loss when calculating the depth loss 111, to mitigate potential inaccuracies with respect to detected obstructions in the frames.

Once the image loss 110 and/or depth loss 111 has been calculated, the model updater 108 can update/train the first model 112 using the calculated image loss 110 and/or depth loss 111. The model updater 108 can use any combination of any of the image loss 110 and/or depth loss 111 to train/update the first model 112. To do so, the model updater 108 can use the image loss 110 and/or depth loss 111, which represents the error produced by executing the first model 112 according to an input image and/or target viewpoint, to iteratively train/update the trainable/updateable parameters of the first model 112. The trainable/updatable parameters may be updated using backpropagation and a suitable optimization algorithm to minimize the error produced by the image loss 110 and/or depth loss 111.

The model updater 108 can iteratively execute the techniques described herein with multiple training/updating examples from one or more sets of sequential images 104 and corresponding sets of depth data 106. Hyperparameters for the training/updating process, which may specify batch size, number of epochs, or sets of sequential images 104 and corresponding depth data 106, may be accessed by the model updater 108 to perform the training/updating process. The hyperparameters for the training/updating process may be stored in memory of the data processing system 102, provided via input to the data processing system 102, or included in a request to perform training of the first model 112, in some implementations.

In some implementations, a validation set, which may include one or more sets of sequential images 104 and corresponding depth data 106, may be used to evaluate the performance of the first model 112 during the training/updating process. For example, the validation set may include a subset of the sets of sequential images 104 and corresponding depth 106, or images/depth maps thereof, that are set aside from the sets of sequential images 104 and sets of corresponding depth maps 106 and used to test/evaluate the accuracy of the first model 112. In a non-limiting example, the accuracy of the first model 112 may be tested/evaluated periodically (e.g., after predetermined numbers of training/updating examples have been used to train/update the first model 112, etc.). This process can be repeated until a training termination condition is reached, such as an accuracy threshold being met or upon using a predetermined number of training/updating examples from the sets of sequential images 104 and corresponding depth maps 106 to train/update the first model 112.

Once the first model is trained, the data processing system 102 can execute the first model 112 to generate one or more output images 118 for one or more training datasets 116. The training datasets 116 can be used by the model trainer 108 to train the vision-based machine-learning model 114 (sometimes referred to herein as the “vision-based model 114”). The vision-based model 114 can be any type of machine-learning model that can receive images (e.g., output images 118), or data generated from images, as input to generate a corresponding output. In one example, the vision-based model 114 can include one or more image segmentation models. Image segmentation models can include vision-based machine-learning models that are trained/updated to classify each pixel in an image, for example, as corresponding to one or more distinct objects or regions. Another example of a vision-based model includes an object detection model (e.g., that regresses bounding shapes to surround objects identified in input images).

As described herein, manually curating datasets corresponding to different viewpoints is impracticable to perform as the number of viewpoints increases. To address these issues, the data processing system 102 can execute the first model 112 to generate one or more output images 118 based on one or more input images (e.g., one or more of the sequential images 104, other input images, etc.) in varying target viewpoints. Example target viewpoints can include, but are not limited to, changes in pitch, changes in height, translational motion, or changes in depth, among others. Examples of images having transformed viewpoints are shown in FIG. 3.

To generate a training dataset 116 for the vision-based model 114, the data processing system 102 can iteratively execute the first model 112 to generate corresponding output images 118 having a specified target viewpoint. The data processing system 102 can initiate generation of one or more output images 118 in response to a request to generate a target dataset 116. The request may specify parameters of the target dataset 116, such as particular target viewpoints and corresponding numbers of output images 118 transformed into said target viewpoints, a size (e.g., number of output images 118) of the training dataset 116, as well as other metadata corresponding to the generation of the training dataset 116. In some implementations, the request may be provided via input to the data processing system 102. In some implementations, the request may be received from one or more external computing systems.

Upon initiating the process to generate the training dataset 116, the data processing system 102 can identify one or more input images for use in generating the output images 118 for the training dataset 116. In some implementations, the input images may be included in one or more sets of sequential images 104. For example, images in the sets of sequential images 104 may be selected to train/update the first model 112 may be used to update/train the vision-based model 114, according to transformed viewpoints. In some implementations, the request to generate the training dataset 116 can specify one or more images to transform into the output images 118, including one or more target viewpoints for said images.

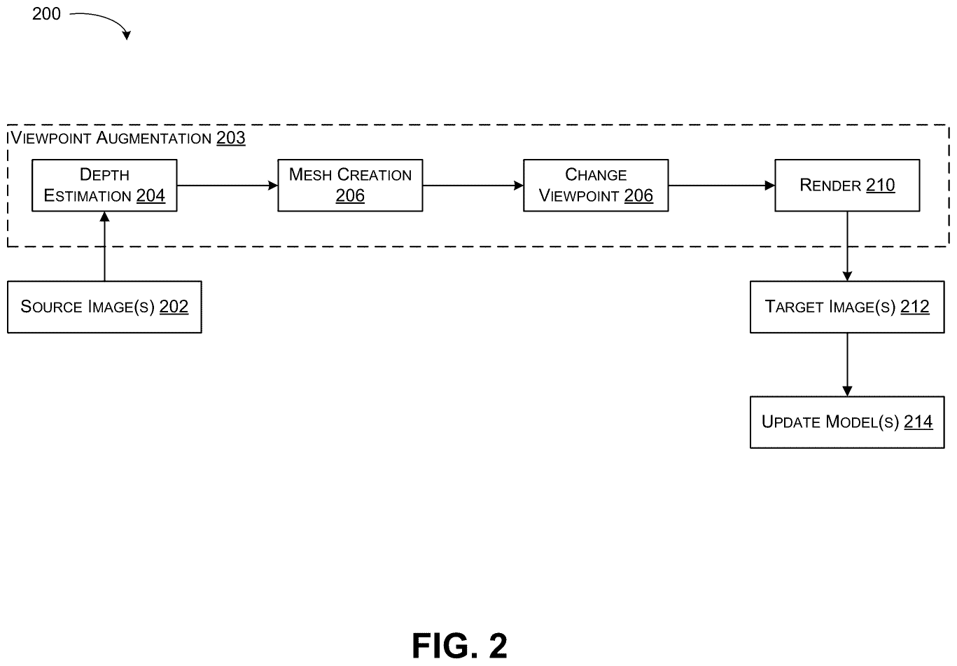

Once the images to transform using the first model 112 have been identified, the data processing system 102 can execute the first model 112 by providing each image along with a corresponding target viewpoint as input to the first model 112. The first model 112 is executed by propagating the data provided as input through each layer of the first model 112 to generate a corresponding warped mesh/lattice, as described herein. The input image is then mapped to the surface of the warped mesh/lattice using a texture sampler of the first model 112. The data processing system 102 can then render the lattice/mesh in the target viewpoint, for example, by executing a rendering process that positions the rendering viewport (e.g., camera) according to the input target viewpoint. For example, without modification, the rendering viewport can be set to capture the entirety of the input image unchanged. The data processing system 102 modify the position of the camera according to the target viewpoint, such that rendering generates an output image 118 as the input image rendered according to the target viewpoint/pose. An example dataflow diagram showing the process of data augmentation using the first model 112 is described in connection with FIG. 2.

Referring now to FIG. 2 in the context of the components described in connection with FIG. 1, illustrated is an example dataflow diagram 200 showing how a viewpoint augmentation process 203 can be used to transform source images 202 to target images 212 having specified viewpoints for training/updating machine-learning models (e.g., the vision-based model 114, etc.), in accordance with some embodiments of the present disclosure. The viewpoint augmentation process 203 can be executed by the data processing system 102, for example, in a request to generate one or more training datasets 116 including target images 212 (e.g., output images 118) having one or more specified target viewpoints.

The viewpoint augmentation process 203 can be used to transform one or more source images 202, each corresponding to a source viewpoint/pose, into a target viewpoint/pose based on the techniques described herein. The source images 202 can be any type of image, including images captured via vehicles having cameras or other types of image/video sensors. The data processing system 102 can perform depth estimation for each pixel in an input source image 202 by providing the source image 202 as input to the first model 112. As described herein, the first model 112 can generate corresponding depth values and grid offsets for each point in a mesh generated using a mesh creation process 206. The mesh creation process 206 can include allocating memory and generating points for a mesh upon which the source image 202 is to be mapped, as described herein.

Once created, the data processing system 102 can warp the mesh generated via the mesh creation process 206 and apply the source image 202 to the warped mesh/lattice using a differentiable texture sampler of the first model 112. The data processing system 102 can modify a viewport/pose/etc. for rendering the mesh by performing a change viewpoint/pose/etc. process 206. The change viewpoint process 206 can include defining a location in three-dimensional space at which the camera/viewport for the rendering process 210 is to be located. The change viewport process 206 can include providing a target location and/or orientation for the camera/viewport.

Additionally, ground truth information (e.g., image segmentations, bounding box indications, etc.) can be transformed using similar techniques. In one example, ground truth segmentations for each pixel in the input source image 202 can be mapped as a texture on the same warped mesh and can be rendered according to the target viewpoint, using the techniques described herein. The resulting segmentations correspond to the generated target image 212 and can be stored in association with the generated target image 212 and used for subsequent update/training processes 214. For example, the data processing system 102 can store any transformed ground truth data in association with the output images 118 in a generated training dataset 116. The input ground truth data can be provided as input to the viewpoint augmentation process 203 with the source image 202, in some implementations.

Once the camera/viewport is positioned and oriented according to the change viewpoint process 206, the data processing system 102 can perform a rendering process 210 to render the mesh according to the target viewpoint and can generate one or more target images 212, which present the input source image 202 as if it were captured from the specified target pose. The data processing system 102 can perform the viewpoint augmentation process 203 using any number of source images 202 and any number of target viewpoints to generate a suitable set of target images 212 (e.g., a training dataset 116) to perform a model training/update process 214.

Referring back to FIG. 1, the model updater 108 can use the training dataset 116 including the output images 118 rendered according to various target viewpoints to train/update one or more vision-based models. To do so, the model updater 108 can access or otherwise identify the output images 118 for use in training/updating the vision-based model 114. Once the training dataset 116 for the vision-based model 114 is accessed, the model updater 108 can provide one or more training/updating examples (e.g., each output image 118 with corresponding target viewpoint) as input to the vision-based model 114 and can execute the vision-based model 114 using the image as input. For example, if the vision-based model 114 includes a neural network, the model updater 108 can execute the vision-based model 114 by performing mathematical computations of each layer (e.g., convolutions, activation functions, multiplications by weight values, etc.) and propagating the resulting data to the next layer in the network. The output produced by the last layer of the vision-based model 114 can be provided as the output of the vision-based model 114.

The output data generated by the vision-based model 114 can be compared to corresponding transformed ground-truth data, which is transformed to conform to the same target viewpoint as the output image 118 provided as input to the vision-based model 114. In doing so, the model updater 108 can calculate an error/loss between the output data generated by the vision-based model 114 and the ground truth data. The error may be calculated using a suitable loss function. In some implementations, multiple training/updating examples may be provided as input to the vision-based model 114 and can be compared to corresponding ground truth data to calculate the error using the loss function. The error calculated using the loss function is then used to iteratively train/update the trainable/updateable parameters of the vision-based model 114. The trainable/updatable parameters may be updated using backpropagation and a suitable optimization algorithm to minimize the error produced by the loss function.

In some implementations, a validation set, which may be a portion of the training dataset 116 withheld for evaluation purposes, may be used to evaluate the performance of the vision-based model 114 during a training/updating process. For example, the validation set may include a subset of the training dataset 116 that is not used to update/train the parameters of the vision-based model 114. In a non-limiting example, the accuracy of the vision-based model 114 may be tested periodically (e.g., after predetermined numbers of training/updating examples have been used to train/update the vision-based model 114, etc.). This process can be repeated until a termination condition is reached, such as an accuracy threshold being met or upon using a predetermined number of training/updating examples to train/update the vision-based model 114.

Referring to FIG. 3, depicted are example images 302, 304, 306, 308, 310, 312, 314, and 316 showing how an input image 302 is transformed into several different viewpoints, in accordance with some embodiments of the present disclosure. As shown, the input image 310 is captured using a wide viewing angle, for example, 120 degrees. In some implementations, following into multiple different viewpoints, a viewing angle of each image can be rectified according to a smaller viewing angle. In this example, transformed images 306-316 are transformed and shown as rectified images having viewing angles of about 50 degrees. An example rectified version of the input image 302 without transformation is shown as the rectified image 304.

Each of the images 306 and 308 are shown as being transformed according to an increase and decrease in pitch of the camera. As shown, the image 306 transformed according to negative 10 degrees of pitch presents more of the hood of the vehicle compared to the rectified image 304, while the image 308 transformed according to positive 10 degrees of pitch presents none of the hood of the vehicle, and more of the sky, compared to the rectified image 304. Similar, but less pronounced, changes are shown in the transformed images 310 and 312, which are transformed according to negative 5 degrees of pitch and positive 5 degrees of pitch, respectively.

The transformed image 314 results from a change in depth, which in this example places the target viewpoint at about the end of the hood of the vehicle (e.g., about 1.5 m forward) that captured the input image 302. As shown, the transformed image 314 appears as a “zoomed in” version of the corresponding rectified image 304. The transformed image 316 results from a target viewpoint specifying a change in height relative to the rectified image 304 (e.g., +0.8 m).

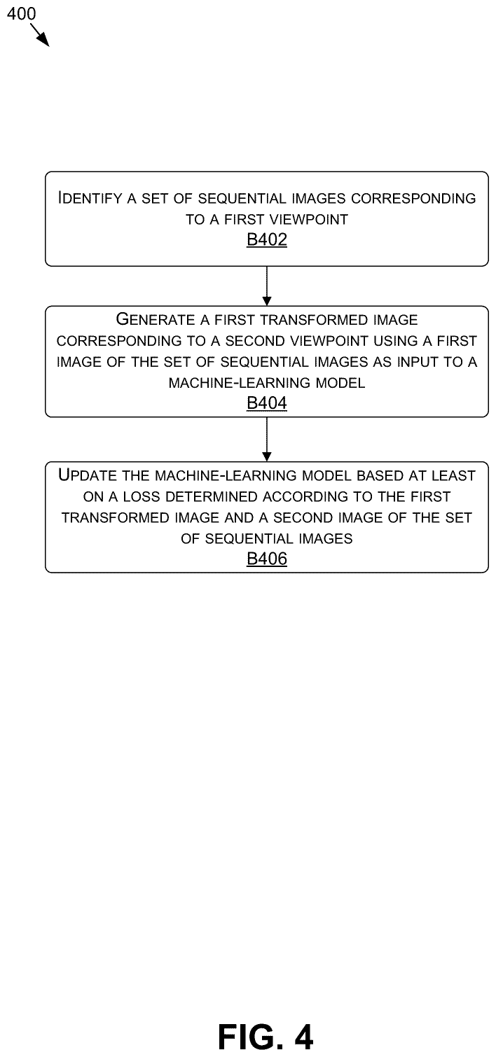

Referring to FIG. 4, illustrated is a flow diagram showing a method 400 of using viewpoint augmentation to transform images to specified viewpoints, in accordance with some embodiments of the present disclosure. Various operations of the method 400 can be implemented by the same or different devices or entities at various points in time. For example, one or more first devices may implement operations relating to training/updating machine-learning models (e.g., the first model 112, the vision-based model 114), and one or more second devices may implement operations relating to executing the machine-learning models to perform image transformation according to the techniques described herein.

The method 400, at block B402, includes identifying a set of sequential images (e.g., the sequential images 104) corresponding to a first viewpoint (e.g., a source viewpoint). The set of sequential images can be used to train/update a machine-learning model (e.g., the first model 112) according to the techniques described herein. The set of sequential images can be identified via input to a computing system or identified in a request to train/update a machine-learning model. The set of sequential images can include, or be stored in association with, a corresponding set of depth data (e.g., the depth data 106).

The method 400, at block B404, includes generating a first transformed image corresponding to a second viewpoint using a first image of the set of sequential images as input to a machine-learning model (e.g., the first machine-learning model 112). As described herein, the machine-learning model can include one or more neural networks that can predict a depth of each pixel in the corresponding image, and one or more grid offsets for a mesh upon which the input image is to be mapped. To do so, the first image can be provided as input to the machine-learning model. A mesh can be generated and warped according to the grid offsets produced by executing the machine-learning model. Once warped, a differentiable texture sampler can be used to map the first image to the warped mesh, and the mesh is rendered according to the target viewpoint to generate the first transformed image, as described herein.

The method 400, at block B406, includes updating/training the machine-learning model based at least on a loss (e.g., the image loss 110, the depth loss 111, combinations thereof) determined according to the first transformed image and a second transformed image of the set of sequential images. As described herein, the loss can be calculated based at least on an input image at least one temporally adjacent image in the sequence. For example, for an image Iₙ, a transformed image can be calculated using the input image Iₙ₋₁ by transforming the image Iₙ₋₁ and/or the image Iₙ₊₁ using the viewpoint of the image I, as the target viewpoint. An image loss (e.g., the image loss 110) can be calculated based at least on an L1 loss and/or an SSIM loss. In some implementations, a depth loss may also be calculated, as described herein. Updating/training the machine-learning model can include updating the trainable/updatable parameters of the machine-learning model based at least on the loss using a suitable backpropagation/optimization technique.

Once the machine-learning model is trained/updated, similar techniques can be used to generate transformed versions (e.g., the output images 118) of input images according to input target viewpoints. The transformed images can be generated to produce a training dataset (e.g., training dataset 116) for one or more vision-based models (e.g., the vision-based machine-learning model 114). The training dataset can be an augmented training dataset that can be used to train/update vision-based models to be robust to several different viewpoints, thereby obviating the need to manually capture different training sets according to desired poses.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

### Example Autonomous Vehicle

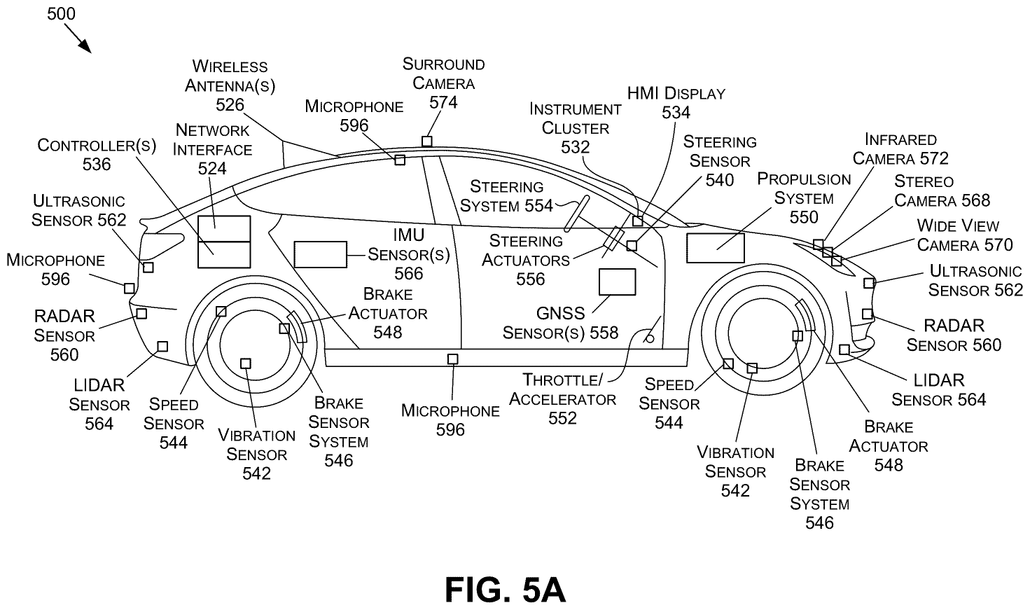

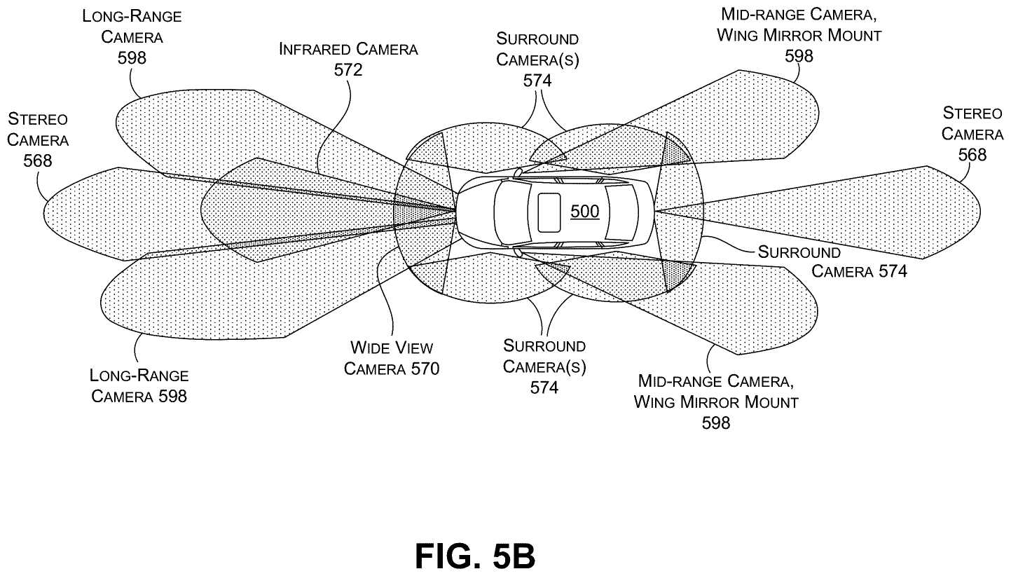

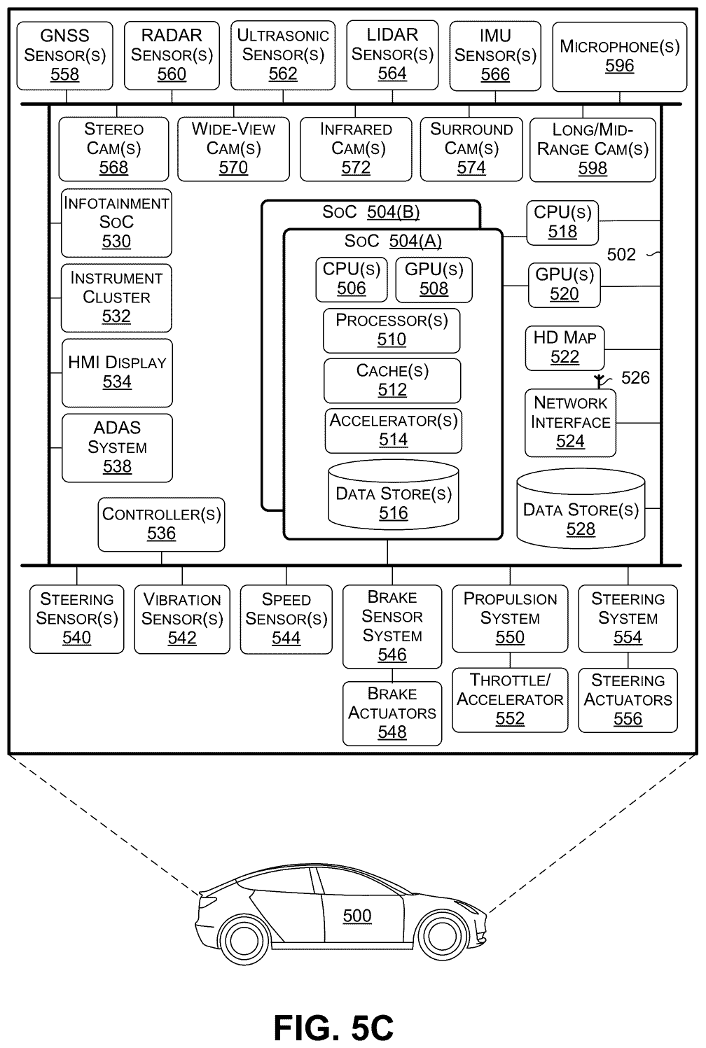

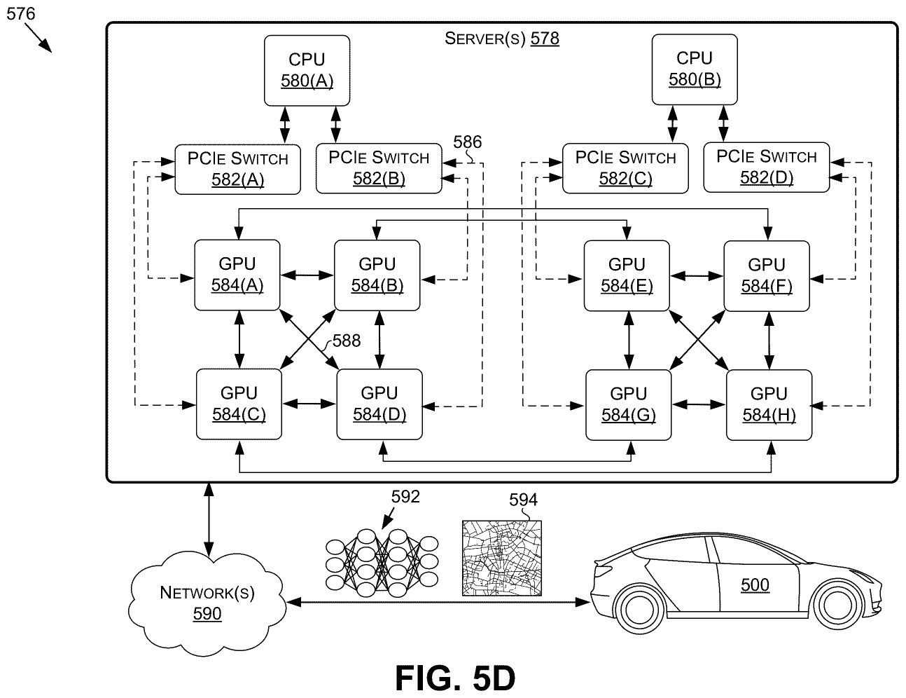

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LiDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. Iₙ other examples, the vector processors that are included in a particular PVA may be configured to employ data parallelism. For example, in some embodiments, the plurality of vector processors included in a single PVA may execute the same computer vision algorithm, but on different regions of an image. Iₙ other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LiDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 512 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. Iₙ-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LiDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. Iₙ contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LiDAR sensor(s) 564. The LiDAR sensor(s) 564 may be used for object and pedestrian detection, emergency braking, collision avoidance, and/or other functions. The LiDAR sensor(s) 564 may be functional safety level ASIL B. In some examples, the vehicle 500 may include multiple LiDAR sensors 564 (e.g., two, four, six, etc.) that may use Ethernet (e.g., to provide data to a Gigabit Ethernet switch).

In some examples, the LiDAR sensor(s) 564 may be capable of providing a list of objects and their distances for a 360-degree field of view. Commercially available LiDAR sensor(s) 564 may have an advertised range of approximately 500 m, with an accuracy of 2 cm-3 cm, and with support for a 500 Mbps Ethernet connection, for example. In some examples, one or more non-protruding LiDAR sensors 564 may be used. In such examples, the LiDAR sensor(s) 564 may be implemented as a small device that may be embedded into the front, rear, sides, and/or corners of the vehicle 500. The LiDAR sensor(s) 564, in such examples, may provide up to a 120-degree horizontal and 35-degree vertical field-of-view, with a 200 m range even for low-reflectivity objects. Front-mounted LiDAR sensor(s) 564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LiDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. Iₙ general, the V2V communication concept provides information about the immediately preceding vehicles (e.g., vehicles immediately ahead of and in the same lane as the vehicle 500), while the 12V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCle switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. Iₙ other examples, such as where performance is less critical, servers powered by CPUs, FPGAs, and other processors may be used for inferencing.

### Example Computing Device

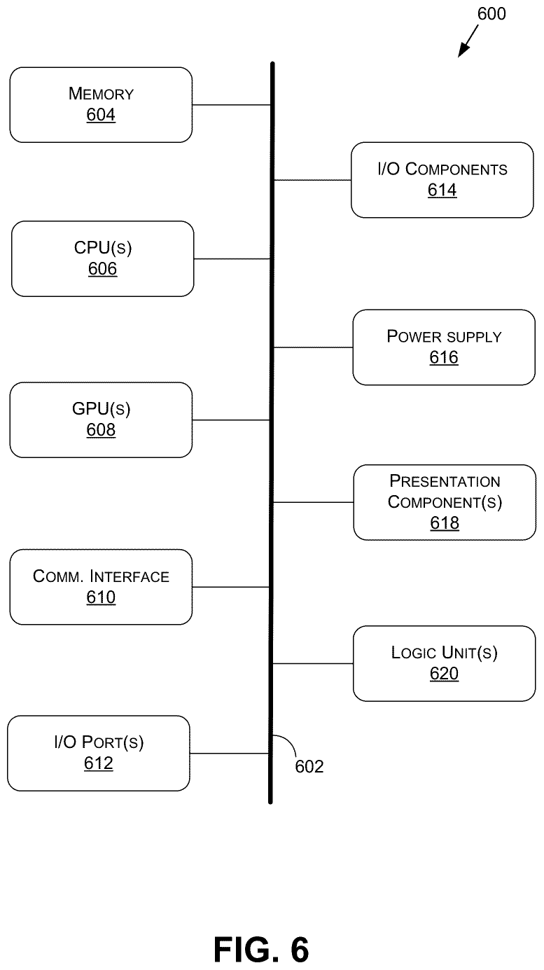

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). Iₙ other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. Iₙ these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. Iₙ embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

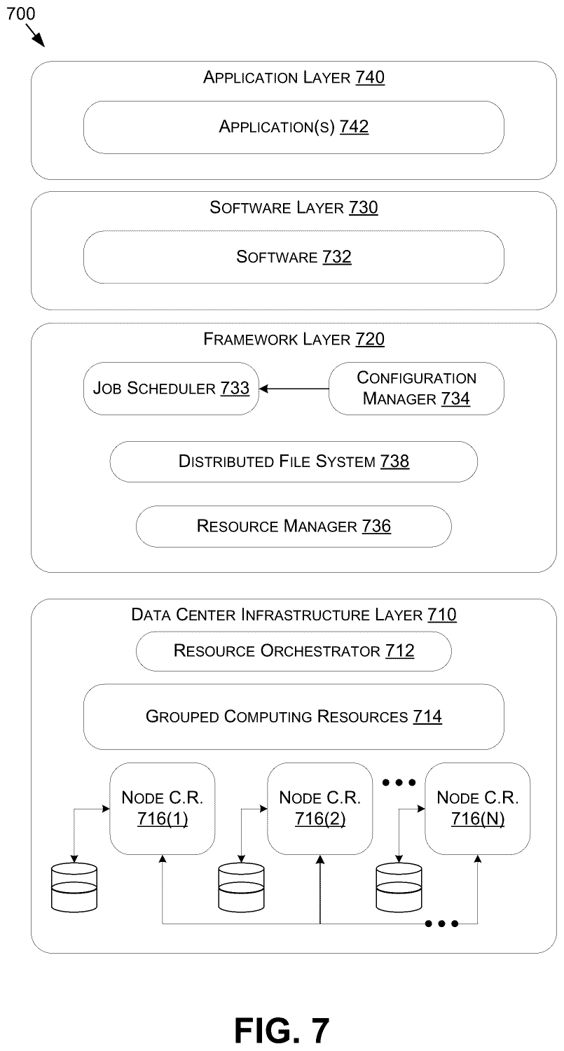

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716 (N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716 (N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
generate, using a machine-learning model and based at least on a first image of a set of sequential images corresponding to a first viewpoint, a first transformed image corresponding to a second viewpoint; and
update one or more parameters of the machine-learning model based at least on a loss determined according to the first transformed image and a second image of the set of sequential images.

2. The processor of claim 1, wherein the one or more circuits are to:
identify a respective depth map associated with each image of the set of sequential images; and
update one or more parameters of the machine-learning model further based at least on a second loss determined according to depth values of one or more mesh faces of an output of the machine-learning model and a respective depth map associated with the second image.

3. The processor of claim 2, wherein the one or more circuits are to update the one or more parameters of the machine-learning model further based at least on a third loss determined according to an estimated depth map of the output of the machine-learning model and a respective depth map associated with the first image.

4. The processor of claim 1, wherein the one or more circuits are to generate at least one mask for at least one image of the set of sequential images.

5. The processor of claim 4, wherein the one or more circuits are to generate the at least one mask using a second machine-learning model updated to predict the at least one mask to correspond to one or more objects depicted as proximate to a device that captured the at least one image.

6. The processor of claim 4, wherein the one or more circuits are to generate the at least one mask using a second machine-learning model updated to predict the at least one mask to correspond to a sky depicted in the at least one image.

7. The processor of claim 1, wherein the one or more circuits are to update one or more parameters of the machine-learning model to render the output in the second viewpoint of the second image of the set of sequential images.

8. The processor of claim 1, wherein the loss comprises one or more of an L1 loss, a structural similarity (SSIM) loss, or a minimal loss.

9. The processor of claim 1, wherein the one or more circuits are to execute the machine-learning model to generate a set of transformed images corresponding to at least the second viewpoint.

10. The processor of claim 1, wherein the one or more circuits are to update one or more parameters of a second machine-learning model using the set of transformed images.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

12. A system comprising:
one or more processors to:
identify a first set of images corresponding to a first viewpoint;
generate, using a machine learning model and based at least on the first set of images, a second set of images corresponding to the first set of images and a second viewpoint; and
update one or more parameters of a second machine-learning model using a dataset comprising the second set of images.

13. The system of claim 12, wherein the one or more processors are to iteratively execute the machine-learning model using a first image of the first set of images as input to generate a plurality of images included in the second set of images, each of the plurality of images corresponding to a respective viewpoint different from the first viewpoint.

14. The system of claim 13, wherein the one or more processors are to execute the machine-learning model further using at least an indication of the second viewpoint.

15. The system of claim 12, wherein the second machine-learning model comprises a segmentation model.

16. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations;
a system for performing operations using a large language model (LLM);
a system for performing operations using a visual language model (VLM);
a system for generating synthetic data;
a system incorporating one or more virtual machines (VMs);
a system implemented at least partially in a data center; or
a system implemented at least partially using cloud computing resources.

17. A method comprising:
identifying a set of sequential images corresponding to a first viewpoint;
generating, a first transformed image corresponding to a second viewpoint; and
updating one or more parameters of the machine-learning model based at least on a loss determined according to the first transformed image and a second image of the set of sequential images.

18. The method of claim 17, further comprising:
identifying a respective depth map associated with each image of the set of sequential images; and
updating the one or more parameters of the machine-learning model further based at least on a second loss determined according to depth values of one or more mesh faces of the output of the machine-learning model and a respective depth map associated with the second image.

19. The method of claim 18, further comprising:
updating the one or more parameters of the machine-learning model further based at least on a third loss determined according to an estimated depth map of the output of the machine-learning model and a respective depth map associated with the first image.

20. The method of claim 17, further comprising:
generating at least one mask for at least one image of the set of sequential images.
